(19) United States
(12) Patent Application Publication
(10) Pub. No.: US 2015/0271273 A1
(43) Pub. Date: Sep. 24, 2015

(54) System for Using a Device as a Side Car

(71) Applicant: CafeX Communications Inc,, Boston, MA (US)

(72) Inventors: Kevin Glass, Cardiff (GB); David Jodoin, Boston, MA (US); Kevin Wiseman, Cardiff (GB)

(73) Assignee: CafeX Communications Inc., Boston, MA (US)

(21) Appl. No.: 14/660,276

(22) Filed: Mar. 17, 2015

Related U.S. Application Data
(60) Provisional application No. 61/955,043, filed on Mar. 18, 2014.

(51) Int. Cl. H04L 29/08

(52) U.S. Cl. CPC H04L 67/141; H04L 67/142

(57) ABSTRACT

A system for sharing a communications session between multiple devices is disclosed. The system may receive a first request to establish the communications session from a first device associated with a user. The system may establish the communications session for the first device associated with the user in response to the first request. Additionally, the system may receive, from a second device associated with the first user, a second request to join the communications session. Furthermore, the system may join the second device to the communications session if the first request and the second request include a common identifier for the first user. Moreover, the system may transmit instructions for causing communications associated with the first device to be presented on a user interface of the second device during the communications session.

### CROSS-REFERENCE TO RELATED APPLICATIONS

This application claims priority to U.S. Provisional Patent Application No. 61/955,043 filed on Mar. 18, 2014, the disclosure of which is hereby incorporated by reference.

### FIELD OF THE INVENTION

The present application relates to techniques for managing and sharing communications sessions between multiple devices, and more particularly, to a system for using a device as a side car.

### BACKGROUND

In today's society, users regularly utilize various types of networks to gain access to the Internet, request and receive various types of content, access software applications, establish communications sessions, conduct business transactions, and perform a variety of other tasks and functions. For example, user devices may utilize such networks to transmit and receive unified communications from other devices connected to such networks. Unified communications often include integrating real-time communication technologies such as, but not limited to, telephone services, video conferencing services, instant messaging services, and speech recognition services with non-real-time communication technologies such as, but not limited to, electronic mail, simple messaging services, and integrated voicemail. Additionally, unified communications systems may enable users to transmit content on one medium and receive the very same content on another medium. By utilizing such unified communications, users may be able to optimize business processes in a more effective and efficient manner.

Despite the current features and functionality provided by current unified communications technologies, there are certain occasions where such current unified communications technologies do not provide an optimized experience for the users. For example, a user may utilize a primary user interface on a device to interact with other users connected with the user during a communications session, but may also desire to utilize another user interface separate from the primary user interface to engage in additional interactions with the other users during the communications session. In an example scenario, a user may need the primary user interface to engage in interactions with other connected users in the context of a business process, but may also need the ability to show the other users live video, still images, or other media content associated with something that is away from the primary user interface that the user is utilizing. In such a scenario, current unified communications technologies or other similar technologies may not provide a seamless, optimized experience that enable the user to readily interact with other users on multiple devices during communications sessions with the other users.

### SUMMARY

A system and accompanying methods for sharing a communications session between multiple devices are disclosed. In particular, the system and methods may allow a first device associated with a user to engage in a communications session with a second device associated with the user, such as a mobile device, that may serve as a second screen or side car for the first device. In order to accomplish this, for business processes that utilize unified communications or other similar communications technologies that form an integral part of the business processes, the communications occurring during the communications session may be pushed to and pulled back from the second device to the first device, pushed to and pulled back from the first device to the second device, or both. If unified communications or other similar elements are being presented on a user interface of the first device or on the user interface of the second device, the communications may remain part of the same user session as any other information presented on either of the user interfaces. In certain embodiments, the user interface of the first device may be utilized for the primary interaction for a selected business process, and the user interface of the second device may be utilized for providing a way of interacting with the business process, but with a subset of information or a different set of information than provided by the user interface of the first device.

Additionally, the user interface of the first device may be generated by a browser-based application or native application executing on the first device, and the user interface of the second device may be generated by another application, such as a native mobile application. The first device may transmit a request to establish the communication session via the application executing on the first device. The request may be received by a gateway or other similar device, which may establish the communications session for the first device in response to the request. Once the communications session is established, the second device associated with the user may transmit a request to join the communications session with the first device. The gateway may receive the request from the second device and join the second device to the communications session if the request from the second device includes an identifier that matches an identifier provided in the request from the first device. Once the first and second devices are joined to the same communications session, communications from first device may be presented on and shared with the second device, and communications from the second device may be presented on and shared with the first device. Additionally, the first and second devices may include a shared view of the user's current state with regard to activities performed during the communications session, and may indicate what communications sessions exist based on the identity of the user utilizing the devices.

In one embodiment, a system for sharing a communications session between multiple devices is disclosed. The system may include a memory that stores instructions and a processor that executes the instructions to perform various operations of the system. In particular, the system may perform an operation that includes receiving a first request to establish the communications session from a first device associated with a first user. The first request may be received from a first application of the first device. Additionally, the system may perform an operation that includes establishing the communications session for the first device associated with the first user. The communications session may be established in response to the first request received from the first device. The system may also perform an operation that includes receiving, from a second device associated with the first user, a second request to join the communications session. The second request may be received from a second application of the second device. Furthermore, the system may perform an operation that includes joining, in response to the second request, the second device to the communications session if the first request and the second request include a common identifier for the first user. Moreover, the system may perform an operation that includes transmitting, if the second device is joined to the communications session, instructions for causing at least a portion of communications associated with the first device to be presented on a user interface of the second device. The communications associated with the first device may be presented during the communications session with the second device.

In another embodiment, a method for sharing a communications session between multiple devices is disclosed. The method may include utilizing a memory that stores instructions, and a processor that executes the instructions to perform the various functions of the method. The method may include receiving a first request to establish the communications session from a first device associated with a first user. The first request may be received from a first application of the first device. Additionally, the method may include establishing the communications session for the first device associated with the first user in response to the first request. Also, the method may include receiving, from a second device associated with the first user, a second request to join the communications session. The second request may be received from a second application of the second device. Furthermore, the method may include joining, in response to the second request, the second device to the communications session if the first request and the second request include a common identifier for the first user. Moreover, the method may include transmitting, if the second device is joined to the communications session, instructions for causing at least a portion of communications associated with the first device to be presented on a user interface of the second device. The communications may be presented during the communications session.

According to yet another embodiment, a computer-readable device having instructions for sharing a communications session between multiple devices is provided. The computer instructions, which when loaded and executed by a processor, may cause the processor to perform operations including: receiving a first request to establish the communications session from a first device associated with a first user, wherein the first request is received from a first application of the first device; establishing the communications session for the first device associated with the first user, wherein the communications session is established based in response to the first request; receiving, from a second device associated with the first user, a second request to join the communications session, wherein the second request is received from a second application of the second device; joining, in response to the second request, the second device to the communications session if the first request and the second request include a common identifier for the first user; and transmitting, if the second device is joined to the communications session, instructions for causing at least a portion of communications associated with the first device to be presented on a user interface of the second device, wherein the communications are presented during the communications session.

These and other features of the systems and methods for sharing a communications session between multiple devices and for using a device as a side car are described in the following detailed description, drawings, and appended claims.

### BRIEF DESCRIPTION OF THE DRAWINGS

FIG. 1 is a schematic diagram of a system for sharing a communications session between multiple devices according to an embodiment of the present disclosure.

FIG. 2 is a schematic diagram illustrating a scenario where a first user is using two devices during a communications session to communicate with a second user using a video conferencing device.

FIG. 3 is a schematic diagram illustrating a scenario where a first user is using two devices during a communications session to communicate with a second user using a device that is using the same application as the first user.

FIG. 4 is a schematic diagram illustrating a scenario where a first user is using two devices during a communications session to communicate with a second user that is also using two devices.

FIG. 5 is a flow diagram illustrating a sample method for sharing a communications session between multiple devices according to an embodiment of the present disclosure.

FIG. 6 is a schematic diagram of a machine in the form of a computer system within which a set of instructions, when executed, may cause the machine to perform any one or more of the methodologies or operations of the systems and methods for sharing a communications session between multiple devices.

### DETAILED DESCRIPTION OF THE INVENTION

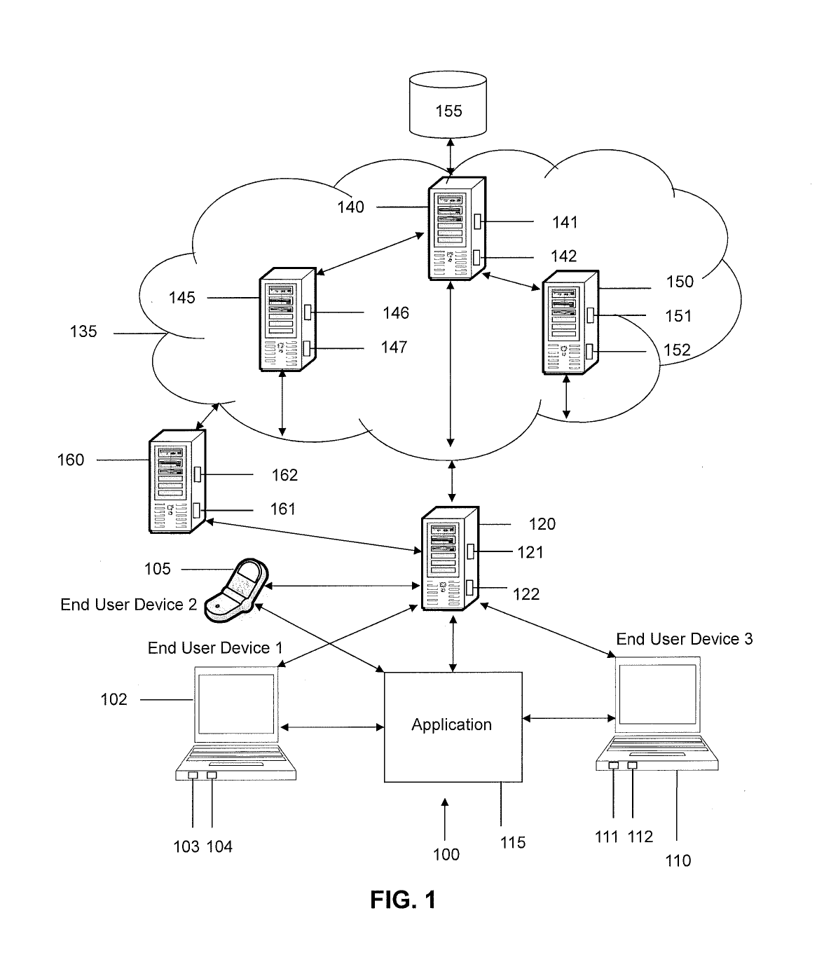

A system 100 and accompanying methods for sharing a communications session between multiple devices and for using a device as a side car are disclosed, such as shown in FIGS. 1-6. In particular, the system 100 and methods may enable a first device associated with a user, such as end-user device 102, to engage in a communications session with a second device associated with the user, such as end-user device 105, which may serve as a second screen or side car for the first device during the communications session. Communications occurring during the communications session may be pushed to and pulled back from the second device to the first device, from the first device to the second device, or both. If unified communications or other similar elements are being presented on a user interface of the first device or on the user interface of the second device, the communications may remain part of the same communications session as any other information presented on either of the user interfaces. In certain embodiments, the user interface of the first device may be utilized for the primary interaction during the communications session, and the user interface of the second device may be utilized for providing a way of interacting during the communications session, but with a subset of information or a different set of information than provided by the user interface of the first device.

The user interface of the first device may be generated by an application executing on the first device, and the user interface of the second device may be generated by another application, such as a native mobile application. The first device may transmit a request to establish the communication session via the application executing on the first device. The request may be received by a gateway, such as gateway 120, or other similar device, which may establish the communications session for the first device in response to the request. Once the communications session is established, the second device associated with the user may transmit a request to join the communications session with the first device. The gateway 120 may receive the request from the second device and join the second device to the communications session if the request from the second device includes a common identifier as provided in the request from the first device. Once the first and second devices are joined to the same communications session, communications from first device may be presented on and shared with the second device, and communications from the second device may be presented on and shared with the first device. Additionally, the first and second devices may include a shared view of the user's current state with regard to activities performed during the communications session, and may indicate what communications sessions exist based on the identity of the user utilizing the devices.

Referring to the drawings and in particular to FIGS. 1-4, the system 100 may provide a more efficient way to tie application sessions on disparate devices together to deliver a coherent, seamless, and consistent user experience. The system 100 may be configured to support, but is not limited to supporting, business process services, cloud computing services, voice-over-internet protocol services (VoIP), software as a service (SaaS) applications, gaming applications and services, productivity applications and services, mobile applications and services, and any other computing applications and services. The system may include a first user that may use end-user device 102, end-user device 105, or a combination thereof, to access content, data, and services generated during a communications session with one or more other users. A communication may include, but is not limited to, audio communications, video communications, messaging communications, network communications, electronic mail communications, conferencing communications, gaming communications, web-based communications, or any combination thereof. A communications session may be any type of session including, but not limited to, a video session, an audio session, a messaging session, an electronic mail session, a conferencing session, a networking session, a gaming session, a web-based session, or any combination thereof. In one embodiment, the end-user devices 102 and 105 may be computers, servers, mobile devices, smartphones, computer tablets, or any other computing devices. In one embodiment, the end-user device 102 may include a memory 103 that includes instructions, and a processor 104 that executes the instructions from the memory 103 to perform various operations that are performed by the end-user device 102. The processor 104 may be hardware, software, or a combination thereof. Illustratively, end-user device 102 is schematically shown as a laptop device in FIG. 1.

Similarly, end-user device 105 may include a memory that includes instructions, and a processor that executes the instructions from the memory to perform various operations that are performed by the end-user device 105. The processor of the end-user device 105 may be hardware, software, or a combination thereof. Illustratively, the end-user device 105 is schematically shown as a smartphone device in FIG. 1. The system 100 may also include a second user that may utilize end-user device 110 to access content, data, and services generated during a communications session with the first user. The end-user device 110 may be a computer, a server, a mobile device, a smartphone, a computer tablet, or any other computing device. In one embodiment, the end-user device 110 may include a memory 111 that includes instructions, and a processor 112 that executes the instructions from the memory 111 to perform various operations that are performed by the end-user device 110. The processor 112 may be hardware, software, or a combination thereof. Illustratively, end-user device 110 is schematically shown as a laptop device in FIG. 1. Additionally, the system 100 may include a gateway 120 that may serve as an intermediary device between the end-user devices 102, 105, and 110. The gateway 120 may include a memory 121 that includes instructions, and a processor 122 that executes the instructions from the memory 121 to perform various operations that are performed by the gateway 120.

The first user may utilize the end-user devices 102 and 105, and the second user may utilize end-user device 110 to access and interact with an application 115 so as to obtain audio content, video content, text content, image content, gaming content, web content, any other type of content, and information or data during a communications session between the first and second users. Additionally, the end users may utilize the end-user devices 102, 105, and 110 to perform a variety of other tasks and functions with respect to the application 115. In certain embodiments, the application 110 may be a software application that may be a business process application, a gaming application, an internet-based application, a browser application, a mobile application, a productivity application, a video application, a music application, a social media application, a web-based application, or any other type of application. In certain embodiments, at least a portion of the application 115 may be configured to execute directly on the end-user devices 102, 105, and 115, however, in other embodiments, the application 115 may be configured to execute on the other devices and components in the system 100. In certain embodiments, a mobile version of the application 115 may be configured to execute on the end-user device 105, while a standard version of the application 115 may be configured to executed on the end-user devices 102 and 110. In certain embodiments, the mobile version of the application 115 may include fewer features or information than the standard version of the application 115.

The application 115 may include various functional features and functionality to the end users using the application 115. For example, if the application 115 is an application for a particular business process, the application 115 may include, but is not limited to, functions that allow for the sharing of media content, the transmission of business data between the first and second users, the storing of user profiles for the first and second users, and the storing of user identifiers for the first and second users. Notably, the functions of the application 115 may be unlimited in scope and type. For example, the application 115 may include functions associated with calculation functions, functions that set up user profiles for the first and second users, functions that create, manage, and delete information and files, functions associated with generating or storing visual and auditory content, functions associated with updating information, messaging functions, or any other types of functions that the application 110 may use to support the users. In one embodiment, the application 115 may include a software-to-software interface that enables the application 115 to communicate with other applications in the system 100 to provide services and functionality needed to support the application 115. The application 115 may also include programming instructions and standards that enable the application 115 to access and communicate with one or more other applications in the system 100. For example, if the application 115 is a business process application, that application 115 may access another application found in the communications network 115 that may provide accounting functionality.

The application 115 and the functions supported by the application 115 may be supported and executed by using any combination of the servers 140, 145, and 150 in the communications network 135 or outside of the communications network 135. In one embodiment, the server 140 may include a memory 141 that includes instructions, and a processor 142 that executes the instructions from the memory 141 to perform various operations that are performed by the server 140. Additionally, the server 145 may include a memory 146 that includes instructions, and a processor 147 that executes the instructions from the memory 146 to perform various operations that are performed by the server 145. Furthermore, the server 150 may include a memory 151 that includes instructions, and a processor 152 that executes the instructions from the memory 151 to perform various operations that are performed by the server 150. The processors 142, 147, and 152 may be hardware, software, or a combination thereof. In certain embodiments, the servers 140, 145, and 150 may be network servers, routers, gateways, computers, mobile devices, or any other suitable computing device.

The communications network 135 of the system 100 may be configured to link each of the devices in the system 100 to one another, and be configured to transmit, generate, and receive any information and data traversing the system 100. In one embodiment, the communications network 135 may include any number of additional servers in addition to the server 140, the server 145, and the server 150. The communications network 135 may also include and be connected to a wireless network, an ethernet network, a satellite network, a broadband network, a cellular network, a private network, a cable network, the Internet, an internet protocol network, a multiprotocol label switching (MPLS) network, a session initiation protocol (SIP) network, a H.323-enabled network, a hypertext transfer protocol (HTTP) enabled network, or any combination thereof. In one embodiment, the communications network 135 may be part of a single autonomous system that is located in a particular geographic region, or be part of multiple autonomous systems that span several geographic regions.

The database 155 of the system 100 may be utilized to store and relay information that traverses the system 100, store content that traverses the system 100, store data about each of the devices in the system 100, and perform any other typical functions of a database. In one embodiment, the database 155 may be connected to or reside within the communications network 135. Additionally, the database 155 may include a processor and memory or be connected to a processor and memory to perform the various operation associated with the database 155. In one embodiment, the database 155 may be connected to the servers 140, 145, and 150, server 160, application 115, and end-user devices 102, 105, 110, 202, and 402. The database 155 may also store information relating to the requests traversing the system 100, data generated from the communications sessions, media content being transferred or received during a communications session, data being generated by the application 115, data responsive to the requests traversing the system 100, and data generated, transmitted, or received by any of the devices in the system 100. Furthermore, the database 155 may be configured to process queries sent to it by any of the devices in the system 100.

Operatively, the system 100 for sharing a communications session between multiple devices and for using a device as a side car may operate as described herewith. In an example scenario, the first user may transmit a first request from end-user device 102 to the gateway 120 to establish a communications session, such as a unified communications session. In one embodiment, the request may be transmitted from the end-user device 102 via the application 115. In certain embodiments, the first request may include an identifier for the first user. The identifier may be a character string, a phone number, an internet protocol address, a communications address, a user name, a user identifier, any identifier, or any combination thereof. When the gateway 120 receives the first request to establish the communications session, the gateway 120 may establish the communications session for the first user. The gateway 120 may establish the communications session based in part on the identifier in the first request. The first user may then transmit a second request from the end-user device 105 to join the communications session with the end-user device 102. The second request may also include an identifier. The second request may be received by the gateway 120 and analyzed.

If the gateway 120 determines that the identifier from the first request and the identifier from the second request do not match, then the gateway 120 may prevent the end-user device 105 from joining the communications session. However, if the gateway 120 determines that the identifier from the first request matches the identifier from the second request, then the gateway 120 may join the end-user device 105 to the communications session with the end-user device 102. When the end-user device 102 and the end-user device 105 are joined to the same communications session, communications, such as unified communications, that are presented on the user interface of the end-user device 102 may also be displayed simultaneously on the user interface of the end-user device 105. In this way, the end-user device 105 may serve as a second screen/side car for the end-user device 102 during the communications session. The system 100 may enable the first user to control the communications session via the end-user device 102, the end-user device 105, or a combination thereof. A second user may also join the communications session by utilizing end-user device 110, end-user device 202, end-user device 402, or a combination thereof. In certain embodiments, the end-user device 110, the end-user device 202, and the end-user device 402 may not be configured control the communications session. However, the second user may utilize end-user device 110, the end-user device 202, and the end-user device 402 to actively participate in the communications session.

In certain embodiments, the end-user device 102 may include a primary user interface for the communications session, and the end-user device 105 may include a secondary user interface for the communications session. The primary user interface may be generated by a browser-based application or a native application executing on the end-user device 102. The secondary user interface may be generated by a native mobile application executing on the end-user device 105. In certain embodiments, the secondary user interface of the end-user device 105 may include a subset of the functionality, information, and/or content that would be provided on the primary user interface. In other embodiments, the secondary user interface may include the same or greater functionality, information, and/or content that would be provided on the primary user interface. When the communications session is started between the end-user device 102 and the end-user device 105, both the primary and secondary interfaces may include a shared view of the first user's current state and may provide an indication of any communications sessions that exist based on the identifier associated with the first user. The first user's current state may include, but is not limited to, an indication of web page that the first user is currently accessing, an indication as to whether media content is being transmitted and/or received, an indication as to whether the first user is updating a user profile, an indication as to whether the end-user device 102 or end-user device 105 has been selected as the primary user interface or the secondary user interface, and an indication as to what functions of the application 115 that the first user is utilizing.

In a sample use case of the system 100, the first user may need the ability to use the primary user interface of the end-user device 102 to interact with a second user using end-user device 110 in the context of a business process. Periodically, the first user may need the ability to move away from the primary user interface of the end-user device 102 during a communications session, but may still need to remain actively involved in the communications session with the second user. In such a scenario, the first user may utilize end-user device 105, which may be a mobile device, to communicate with the second user during the communications session. The end-user device 105 may join the communications session with the end-user device 102 and end-user device 110. In certain embodiments, the end-user device 105 may instantly recognize that the first user is already in the communications session using end-user device 102 when the first user launches an application on the end-user device 105 that is a companion to the application executing on the end-user device 102. In such embodiments, the end-user device 105 does not need to send an explicit request to the gateway 120 to join the communications session. Instead, upon the instant recognition of the active communications session with end-user device 102, the end-user device 105 may be joined to the communications session based on providing an identifier that matches an identifier provided by end-user device 102 for the communications session. Communications and content from the end-user device 102 may be pulled from the end-user device 102 to be presented on end-user device 105. The communications and content may be pulled from the end-user device 102 via the gateway 120. If the first user decides to use end-user device 102 as their primary device during the communications session, communications and content may be pulled from the end-user device 105 to be presented on the end-user device 102.

In certain additional embodiments, the communications generated and/or provided by the end-user device 102 and end-user device 105 during the communications session may be presented as a single communications session to the second user that is utilizing end-user device 110, 202, and/or 402. In other embodiments, the second user may selectively choose to utilize multiple end-user devices 110, 202, 402 during the communications session, and selectively choose to split the communications session into multiple communications sessions based on the second user's preferences. In further embodiments, each of the end-user devices 102, 105, 110, 202, 402 may be configured to perform the same communications and interactions, and the communications and interactions may be delivered through one or more end-user devices 102, 105, 110, 202, 402 based on the needs of a particular user connected to the communications session. In still further embodiments, each of the end-user devices 102, 105, 110, 202, 402 may be configured to support the same or similar communications sessions provided that an application (e.g. application 115) on the receiving end of the communications during the communications session is capable of engaging in the communications session and handling interactions during the communications session. As an example, end-user device 102 may be streaming video content of the first user, while the end-user device 105 streams video content of a problem that the first user wants the second user to view on end-user device 110 during the communications session.

In certain embodiments, the first user may manage the communications session by using the primary user interface on the end-user device 102 and/or by using the secondary user interface on the end-user device 105 based on user preferences stored for the first user. The user preferences may be stored in the application 115 and/or in a user profile of the first user. In certain embodiments, this may allow the end-user device 105 to be utilized as a desk phone and to free up space on the first user's primary user interface for a particular business process. The session may be pulled back to the primary user interface of the end-user device 102 and subsequently pushed back to the secondary user interface of the end-user device 105. In certain embodiments, the system 100 may enable the first or second user to select a mode that dictates which end-user device 102, 105, 110, 202, 402 should be transmitting, generating, and/or receiving content during a communications session. The mode may be changed at any time during the communications session or otherwise depending on each of the users' needs. In certain embodiments, the mode may be selected via the application 115 and the mode selection may be pushed to any of the devices of the system 100. In other embodiments, the mode may be set prior to the establishment of the communications session.

In another sample use case of the system 100, the first user may need the ability to use the primary interface of the end-user device 102 to interact with the second user in the context of a business process, and may need the ability to periodically show the second user live video or still images (e.g. via a camera of the end-user devices 102, 105) of something that is away from the primary user interface of the end-user device 102. For example, an engineer in the field may be utilizing end-user device 102, which may be a laptop, as the primary user interface for the communications session, and may be utilizing end-user device 105 as a secondary mobile user interface for the communications session. The engineer may use end-user device 105 to show the second user a visual feed of equipment from any angle requested by the second user, such as by utilizing a camera of the end-user device 105. As another example, this use case may be equally applicable to medical use cases where a practitioner may have a need to refer to a remote expert in real-time.

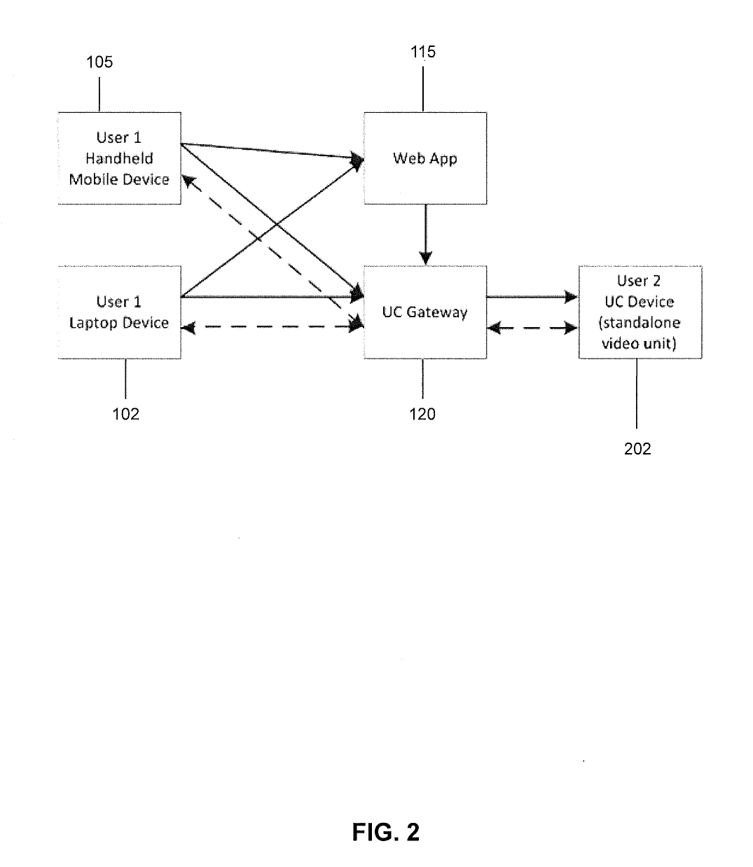

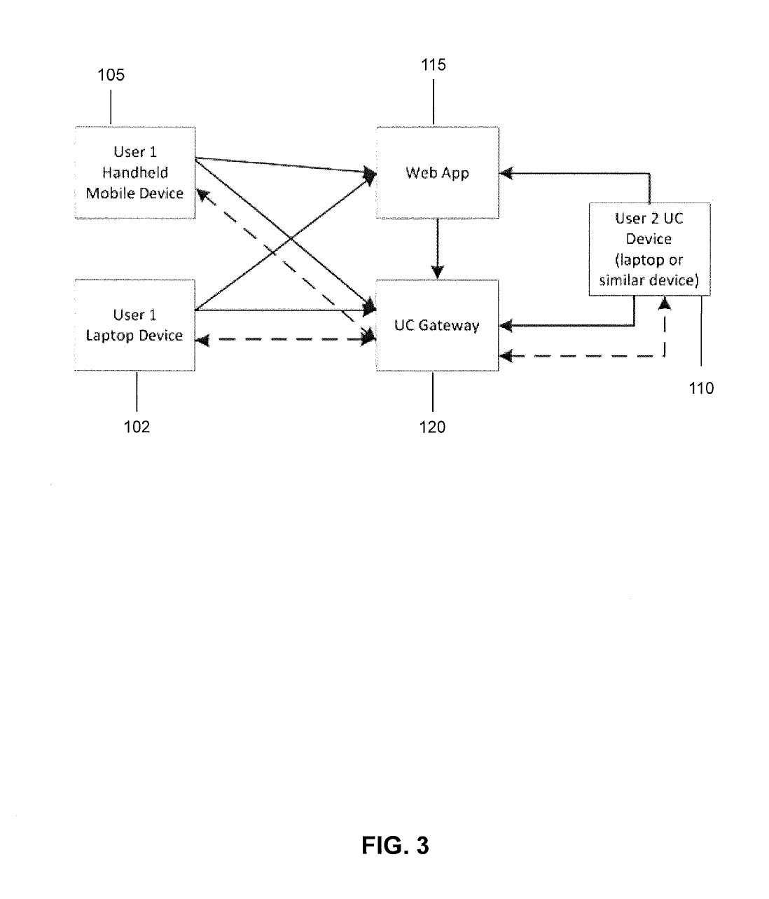

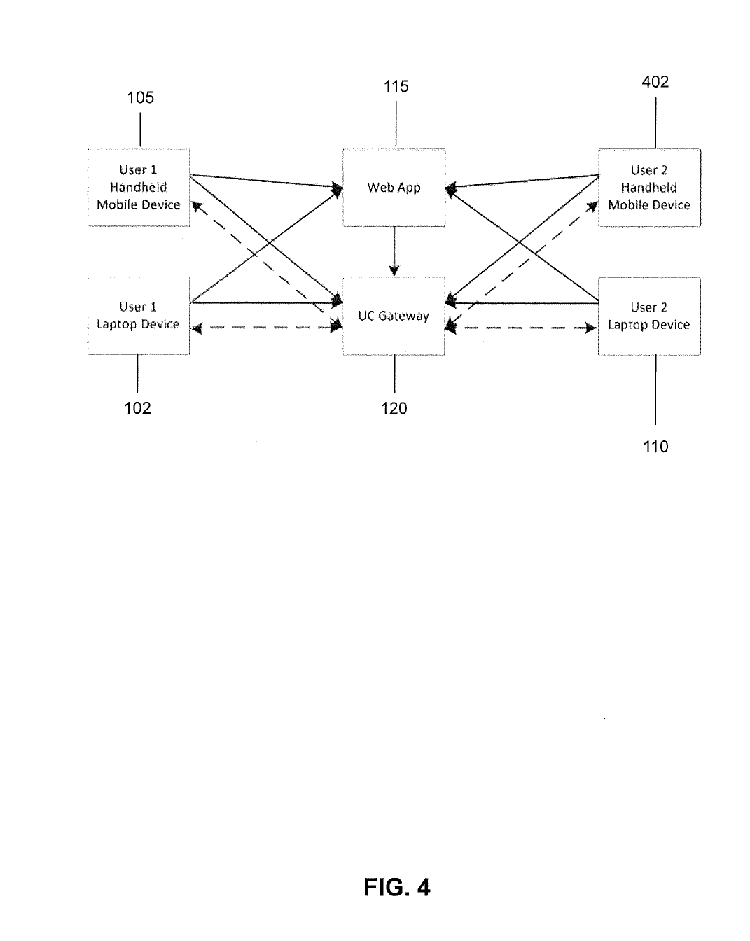

FIGS. 2-4 illustrate additional sample scenarios in which the system 100 may operate. The solid lines in FIGS. 2-4 illustrate request/response messages flowing between the end-user devices 102, 105, 110, 202, 402, the application 115 (e.g. application data, typically HTTP), and the gateway 120 (e.g. for communication signaling, such as HTTP or session initiation protocol depending on the type of device.) The dashed lines in FIGS. 2-4 illustrate media content being transmitted between the end-user devices 102, 105, 110, 202, 402 and the gateway 120. FIG. 2 illustrates a scenario where the first user is using end-user device 102 and end-user device 105 during a communications session with the second user, who is using end-user device 202. In this scenario, end-user device 202 may be a unified communications device, such a video conference device that utilizes session initiation protocol, H.323, or other protocols. FIG. 3 illustrates a sample scenario where the first user is using end-user device 102 and end-user device 105 during a communications session with the second user, who is using only end-user device 110. In this scenario, the first user and the second user may communicate via the communications session by utilizing the same application 115. FIG. 4 illustrates yet another sample scenario where the first user is using end-user device 102 and end-user device 105 during a communications session with the second user, who is using both end-user device 110 and end-user device 402. End-user device 402 may be a handheld mobile device or other appropriate device. In this scenario, both the first user and the second user may be using the end-user device 105 and the end-user device 402 respectively as second screens/side cars.

Notably, as shown in FIG. 1, the system 100 may perform any of the operative functions disclosed herein by utilizing the processing capabilities of server 160, the storage capacity of the database 155, or any other component of the system 100 to perform the operative functions disclosed herein. The server 160 may include one or more processors 162 that may be configured to process any of the various functions of the system 100. The processors 162 may be software, hardware, or a combination of hardware and software. Additionally, the server 160 may also include a memory 161, which stores instructions that the processors 162 may execute to perform various operations of the system 100. For example, the server 160 may assist in processing loads handled by the various devices in the system 100, such as, but not limited to, receiving requests from the end-user devices 102, 105, 110, 202, and 402 to join a communications session, establishing a communications session, determining if the requests from the end-user devices 102, 105, 110 202, and 402, include a common identifier for a user, joining the end-user devices 102, 105, 110, 202, and 402 to the communications session, preventing the end-user devices 102, 105, 110, 202, and 402 from joining the communications session, transmitting instructions for causing a portion of communications to be presented on the end-user devices 102, 105, 110, 202, and 402, and performing any other suitable operations conducted in the system 100 or otherwise. In one embodiment, multiple servers 160 may be utilized to process the functions of the system 100. The server 160 and other devices in the system 100, may utilize the database 155 for storing data about the devices in the system 100 or any other information that is associated with the system 100. In one embodiment, multiple databases 155 may be utilized to store data in the system 100.

Although FIG. 1 illustrates specific example configurations of the various components of the system 100, the system 100 may include any configuration of the components, which may include using a greater or lesser number of the components. For example, the system 100 is illustratively shown as including an end-user device 102, an end-user device 105, an end-user device 110, an application 115, a gateway 120, a communications network 135, a server 140, a server 145, a server 150, a server 160, and a database 155. However, the system 100 may include multiple end-user devices 102, 105, 110, multiple applications 115, multiple communications networks 135, multiple servers 140, 145, 150, and 160, multiple databases 155, or any number of any of the other components in the system 100. Furthermore, in one embodiment, substantial portions of the functionality and operations of the system 100 may be performed by other networks and systems that are connected to system 100.

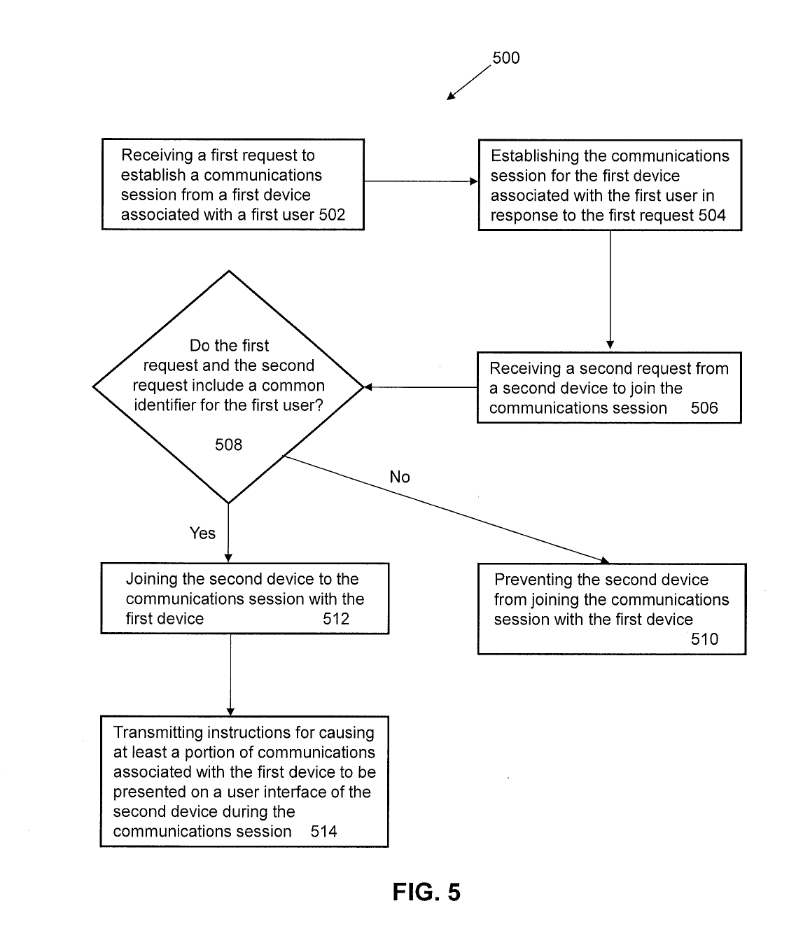

As shown in FIG. 5, an exemplary method 500 for sharing a communications session between multiple devices is schematically illustrated, and may include, at step 502, receiving, from a first device associated with a first user, a first request to establish the communications session. In certain embodiments, the first device may be the end-user device 102, the end-user device 105, the end-user device 110, the end-user device 202, the end-user device 402, any combination thereof, or any other appropriate device. In certain embodiments, the first request may be received via the application 115 or directly from the end-user devices 102, 105, 110, 202, and 402. The first request may be received by a gateway, such as gateway 120, which may be a unified communications gateway. At step 504, the method 500 may include establishing the communications session for the first device associated with the first user in response to the first request. In certain embodiments, the communications session may be established by the gateway 120, the end-user devices 102, 105, 110, 202, 402, any combination thereof, or other appropriate device.

At step 506, the method 500 may include receiving a second request from a second device to join the communications session. In certain embodiments, the second device may be the end-user device 102, the end-user device 105, the end-user device 110, the end-user device 202, the end-user device 402, any combination thereof, or any other appropriate device. In certain embodiments, the second request may be received via the application 115 or directly from the end-user devices 102, 105, 110, 202, and 402. The second request may be received by the gateway 120 for processing. At step 508, the method 500 may include determining if the first request and the second request include a common identifier associated with the first user. The common identifier may be a character string, a phone number, an internet protocol address, a communications address, a user name, a user identifier, any identifier, or any combination thereof. In certain embodiments, the determination may be performed by the gateway 120, the servers 140, 145, 150, and 160, any combination thereof, or by any other appropriate device.

At step 510, the method 500 may include preventing the second device from joining the communications session with the first device if the first request and the second request do not include the common identifier. In certain embodiments, the second device may be prevented from joining the communications session with the first device by utilizing the gateway 120, the servers 140, 145, 150, and 160, any combination thereof, or by any other appropriate device. The method 500 may include, at step 512, joining the second device to the communications session with the first device if the first request and the second request are determined to include the common identifier. In certain embodiments, the joining of the second device to the communications session with the first device may be performed by utilizing the gateway 120, the servers 140, 145, 150, and 160, any combination thereof, or by any other appropriate device. At step 514, the method 500 may include transmitting instructions for causing at least a portion of communications associated with the first device to be presented on a user interface of the second device during the communications session. In certain embodiments, the transmitting of the instruction may be performed by utilizing the gateway 120, the servers 140, 145, 150, and 160, any combination thereof, or by any other appropriate device.

In certain embodiments, the system 100 and methods may provide for additional functionality and features. For example, when the first user is already connected to a communications session using end-user device 102, and the first user wants to connect the end-user device 105 to the same communications session, the first user does not need to explicitly send a request to join the communications session with the end-user device 102. Instead, when the first user activates and/or logs into the end-user device 105, the system 100 may automatically determine based on an identifier associated with the end-user device 105 that the end-user device 105 should be joined to the communications session with end-user device 102.

The system 100 and methods may be further supplemented to incorporate telemetry data or other similar data during the communications sessions to enhance the user experience. In particular, the system 100 and the devices in the system 100 may obtain telemetry data such as, but not limited to, global positioning data, longitude data, latitude data, directional data, speed data, other data, and any combination thereof. The global positioning data, longitude data, and latitude data may be utilized indicate a location of a selected end-user device 102, 105, 110, 202, 402. The directional data may be utilized to indicate a direction of a selected end-user device 102, 105, 110, 202, 402, and the speed data may be utilized to indicate the speed at which a selected end-user device 102, 105, 110, 202, 402 is moving. The telemetry data may be provided to each of the users participating in the communications session, and may be utilized to inform recipient users of a particular stream provided by a transmitting user with contextual information associated with the stream provided by the transmitting user and/or information associated with an end-user device 102, 105, 110, 202, 402 that the transmitting user is using.

It is important to note that the methods described above may incorporate any of the functionality, devices, and/or features of the system 100 and subsystems described above, or otherwise, and are not intended to be limited to the description or examples provided herein.

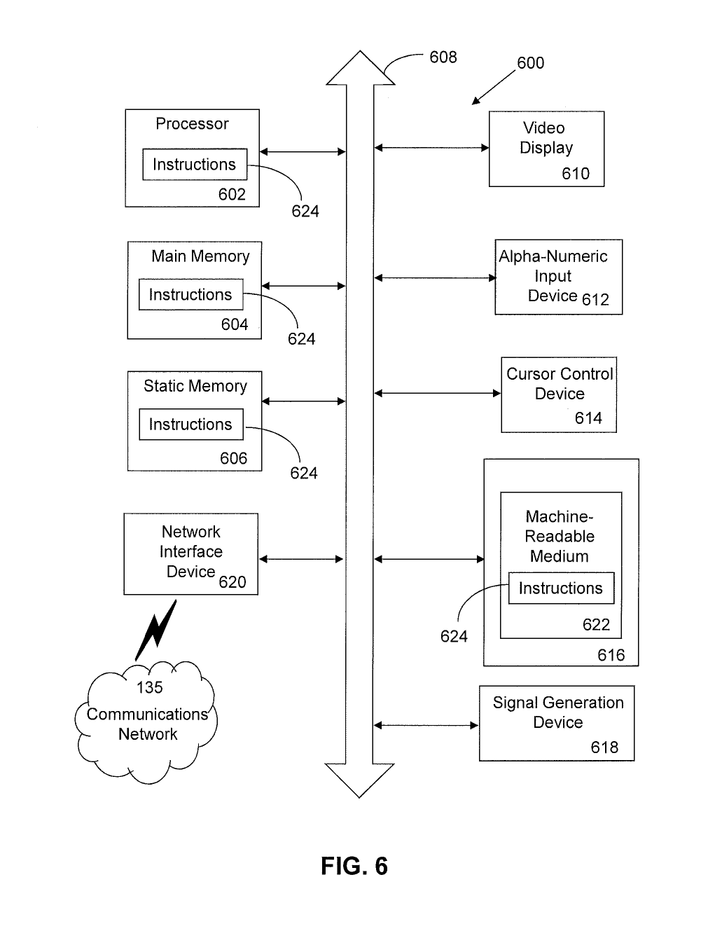

Referring now also to FIG. 6, at least a portion of the methodologies and techniques described with respect to the exemplary embodiments of the system 100 can incorporate a machine, such as, but not limited to, computer system 600, or other computing device within which a set of instructions, when executed, may cause the machine to perform any one or more of the methodologies or functions discussed above. The machine may be configured to facilitate various operations conducted by the system 100. For example, the machine may be configured to, but is not limited to, assist the system 100 by providing processing power to assist with processing loads experienced in the system 100, by providing storage capacity for storing instructions or data traversing the system 100, or by assisting with any other operations conducted by or within the system 100.

In some embodiments, the machine may operate as a standalone device. In some embodiments, the machine may be connected (e.g., using communications network 135, another network, or a combination thereof) to and assist with operations performed by other machines, such as, but not limited to, the end-user device 102, end-user device 105, the end-user device 110, the end-user device 202, the end-user device 402, the gateway 120, the server 140, the server 145, the server 150, the database 155, the server 160, or any combination thereof. The machine may be connected with any component in the system 100. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU, or both), a main memory 604 and a static memory 606, which communicate with each other via a bus 608. The computer system 600 may further include a video display unit 610, which may be, but is not limited to, a liquid crystal display (LCD), a flat panel, a solid state display, or a cathode ray tube (CRT). The computer system 600 may include an input device 612, such as, but not limited to, a keyboard, a cursor control device 614, such as, but not limited to, a mouse, a disk drive unit 616, a signal generation device 618, such as, but not limited to, a speaker or remote control, and a network interface device 620.

The disk drive unit 616 may include a machine-readable medium 622 on which is stored one or more sets of instructions 624, such as, but not limited to, software embodying any one or more of the methodologies or functions described herein, including those methods illustrated above. The instructions 624 may also reside, completely or at least partially, within the main memory 604, the static memory 606, or within the processor 602, or a combination thereof, during execution thereof by the computer system 600. The main memory 604 and the processor 602 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium 622 containing instructions 624 so that a device connected to the communications network 135, other network, or both, can send or receive voice, video or data, and to communicate over the communications network 135, other network, or both, using the instructions. The instructions 624 may further be transmitted or received over the communications network 135, other network, or both, via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The terms “machine-readable medium” or “machine-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium” or “machine-readable device” may be non-transitory. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

We claim:

1. A system for sharing a communications session between multiple devices, the system comprising:
a memory that stores instructions;
a processor that executes the instructions to perform operations, the operations comprising:
receiving a first request to establish the communications session from a first device associated with a first user, wherein the first request is received from a first application of the first device;
establishing the communications session for the first device associated with the first user, wherein the communications session is established based in response to the first request;
receiving, from a second device associated with the first user, a second request to join the communications session, wherein the second request is received from a second application of the second device;
joining, in response to the second request, the second device to the communications session if the first request and the second request include a common identifier for the first user; and
transmitting, if the second device is joined to the communications session, instructions for causing at least a portion of communications associated with the first device to be presented on a user interface of the second device, wherein the communications are presented during the communications session.

2. The system of claim 1, wherein the operations further comprise preventing the second device from joining the communications session if the first request and the second request do not include a common identifier for the first user.

3. The system of claim 1, wherein the operations further comprise enabling the first application and the second application to share user state information when the second device is joined to the communications session.

4. The system of claim 1, wherein the operations further comprise transmitting instructions for causing at least a portion of communications generated by the second device to be presented on a user interface of the first device.

5. The system of claim 1, wherein the first device is a non-mobile device and the second device is a mobile device.

6. The system of claim 1, wherein the operations further comprise enabling the communications session to be controlled by the first device, the second device, or a combination thereof.

7. The system of claim 1, wherein the communications associated with the first device comprise unified communications that include voice communications, messaging communications, audio communications, video communications, text communications, or a combination thereof.

8. The system of claim 1, wherein the operations further comprise sharing, via the communications session, the communications with a third device associated with a second user, wherein the third device does not have control of the communications session.

9. The system of claim 1, wherein the operations further comprise providing a first mode for causing the communications to be transmitted from the first device, and wherein the operations further comprise providing a second mode for causing the communications to be transmitted from the second device.

10. A method for sharing a communications session between multiple devices, the method comprising:
receiving a first request to establish the communications session from a first device associated with a first user, wherein the first request is received from a first application of the first device;
establishing, by utilizing instructions from memory that are executed by a processor, the communications session for the first device associated with the first user, wherein the communications session is established based in response to the first request;
receiving, from a second device associated with the first user, a second request to join the communications session, wherein the second request is received from a second application of the second device;
joining, in response to the second request, the second device to the communications session if the first request and the second request include a common identifier for the first user; and
transmitting, if the second device is joined to the communications session, instructions for causing at least a portion of communications associated with the first device to be presented on a user interface of the second device, wherein the communications are presented during the communications session.

11. The method of claim 10, further comprising preventing the second device from joining the communications session if the first request and the second request do not include a common identifier for the first user.

12. The method of claim 10, further comprising enabling the first application and the second application to share user state information when the second device is joined to the communications session.

13. The method of claim 10, further comprising transmitting instructions for causing at least a portion of communications generated by the second device to be presented on a user interface of the first device.

14. The method of claim 10, wherein the first device is a non-mobile device and the second device is a mobile device.

15. The method of claim 10, further comprising enabling the communications session to be controlled by the first device, the second device, or a combination thereof.

16. The method of claim 10, wherein the communications associated with the first device comprise unified communications that include voice communications, messaging communications, audio communications, video communications, text communications, or a combination thereof.

17. The method of claim 10, further comprising sharing, via the communications session, the communications with a third device associated with a second user, wherein the third device does not have control of the communications session.

18. The method of claim 10, further comprising providing a first mode for causing the communications to be transmitted from the first device, and further comprising providing a second mode for causing the communications to be transmitted from the second device.

19. A computer-readable device comprising instructions, which when loaded and executed by a processor, cause the processor to perform operations comprising:
receiving a first request to establish a communications session from a first device associated with a first user, wherein the first request is received from a first application of the first device;
establishing the communications session for the first device associated with the first user, wherein the communications session is established based in response to the first request;
receiving, from a second device associated with the first user, a second request to join the communications session, wherein the second request is received from a second application of the second device;
joining, in response to the second request, the second device to the communications session if the first request and the second request include a common identifier for the first user; and
transmitting, if the second device is joined to the communications session, instructions for causing at least a portion of communications associated with the first device to be presented on a user interface of the second device, wherein the communications are presented during the communications session.

20. The computer-readable device of claim 19, wherein the operations further comprise enabling the first application and the second application to share user state information when the second device is joined to the communications session.
